(19) United States
(12) Patent Application Publication
(10) Pub. No.: US 2025/0226963 A1
(43) Pub. Date: Jul. 10, 2025

(54) TRANSMISSION DIRECTION DETERMINATION METHOD AND APPARATUS, COMMUNICATION DEVICE, AND STORAGE MEDIUM

(71) Applicant: Beijing Xiaomi Mobile Software Co., Ltd., Beijing (JP)

(72) Inventor: Yajun ZHU, Beijing (CN)

(21) Appl. No.: 18/850,913

(22) PCT Filed: Mar. 29, 2022
(86) PCT No.: PCT/CN2022/083856

§ 371 Date: Sep. 25, 2024

(51) Int. Cl. H04L 5/00

(52) U.S. Cl. CPC H04L 5/0098; H04L 5/0044

(57) ABSTRACT

Provided in embodiments of the present disclosure is a transmission direction determination method. The method is executed by an access network device. The method comprises: sending configuration information of at least one sub-band to a terminal, wherein the configuration information is used for the terminal to determine: the transmission direction of transmitting data on a target transmission unit on the basis of the sub-band.

### CROSS-REFERENCE TO RELATED APPLICATIONS

The present disclosure is a U.S. national phase of PCT Application No. PCT/CN2022/083856 filed on Mar. 29, 2022, the content of which is hereby incorporated by reference in its entirety.

### TECHNICAL FIELD

The present disclosure relates to, but is not limited to, a field of a wireless communication technology, and in particular, to methods for determining transmission direction, an access network device, a terminal, and storage mediums.

### BACKGROUND

Full duplex transmission and half duplex transmission are two typical data transmission manners. For the full duplex transmission, bidirectional transmission of signals may be executed simultaneously, which may thus improve throughput, reduce transmission delay, and enhance an uplink coverage range. In a wireless communication technology, an available frequency resource may be divided into several sub-bands, a channel quality of each of the sub-bands may be respectively measured, and the frequency resource in a sub-band with minimum transmission signal fading is selected and allocated to a user, to implement frequency selective scheduling, which is also referred to as sub-band scheduling.

### SUMMARY

According to a first aspect of the embodiments of the present disclosure, a method for determining transmission direction is provided. The method is executed by an access network device, and the method includes: sending configuration information of at least one sub-band to a terminal; where the configuration information is for the terminal to determine one or more transmission directions in which data is transmitted on the at least one sub-band in one or more target transmission units.

According to a second aspect of the embodiments of the present disclosure, a method for determining transmission direction is provided. The method is executed by a terminal, and the method includes: receiving configuration information of at least one sub-band sent by an access network device; and determining, according to the configuration information, one or more transmission directions in which data is transmitted on the at least one sub-band in one or more target transmission units.

According to a third aspect of the embodiments of the present disclosure, an access network device is provided, including; a processor; and a memory storing instructions executable by the processor; where the processor is configured to implement, when executing the executable instructions, the method in the first aspect of the embodiments of the present disclosure.

According to a fourth aspect of the embodiments of the present disclosure, a terminal is provided, including: a processor; and a memory storing processor executable instructions; where the processor is configured to implement, when executing the executable instructions. the method in the second aspect of the embodiments of the present disclosure.

According to a fifth aspect of the embodiments of the present disclosure, a computer storage medium is provided. The computer storage medium stores a computer executable program. When the executable program is executed by a processor, the method in the first aspect of the embodiments of the present disclosure is implemented.

According to a sixth aspect of the embodiments of the present disclosure, a computer storage medium is provided. The computer storage medium stores a computer executable program. When the executable program is executed by a processor, the method in the second aspect of the embodiments of the present disclosure is implemented.

### BRIEF DESCRIPTION OF DRAWINGS

FIG. 1 is a schematic structural diagram of a wireless communication system shown according to an exemplary embodiment.

FIG. 2 is a schematic diagram of channel interference shown according to an exemplary embodiment.

FIG. 3 is a schematic diagram of channel interference shown according to an exemplary embodiment.

FIG. 4 is a schematic flowchart of a method for determining transmission direction shown according to an exemplary embodiment.

FIG. 5 is a schematic diagram of configuring a transmission direction shown according to an exemplary embodiment.

FIG. 6 is a schematic flowchart of a method for determining transmission direction shown according to an exemplary embodiment.

FIG. 7 is a schematic flowchart of a method for determining transmission direction shown according to an exemplary embodiment.

FIG. 8 is a schematic flowchart of a method for determining transmission direction shown according to an exemplary embodiment.

FIG. 9 is a schematic flowchart of a method for determining transmission direction shown according to an exemplary embodiment.

FIG. 10 is a schematic flowchart of a method for determining transmission direction shown according to an exemplary embodiment.

FIG. 11 is a schematic flowchart of a method for determining transmission direction shown according to an exemplary embodiment.

FIG. 12 is a schematic flowchart of a method for determining transmission direction shown according to an exemplary embodiment.

FIG. 13 is a schematic flowchart of a method for determining transmission direction shown according to an exemplary embodiment.

FIG. 14 is a schematic flowchart of a method for determining transmission direction shown according to an exemplary embodiment.

FIG. 15 is a schematic flowchart of a method for determining transmission direction shown according to an exemplary embodiment.

FIG. 16 is a schematic flowchart of a method for determining transmission direction shown according to an exemplary embodiment.

FIG. 17 is a schematic diagram of an apparatus for determining transmission direction shown according to an exemplary embodiment.

FIG. 18 is a schematic diagram of an apparatus for determining transmission direction shown according to an exemplary embodiment.

FIG. 19 is a schematic structural diagram of a terminal shown according to an exemplary embodiment.

FIG. 20 is a block diagram of a base station shown according to an exemplary embodiment.

### DETAILED DESCRIPTION

Exemplary embodiments will be described in detail herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. Rather, they are only examples of apparatuses and methods that are consistent with some aspects of embodiments of the present disclosure as detailed in the appended claims.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, the term “if”' used herein may be interpreted as “when,” “while,” or “in response to determining.”

For purposes of brevity and ease of understanding, the used term is “greater than” or “less than” when representing a size relationship herein. However, those skilled in the art may understand that the term “greater than” also covers the meaning of “greater than or equal to”, and the term “less than” also covers the meaning of “less than or equal to”.

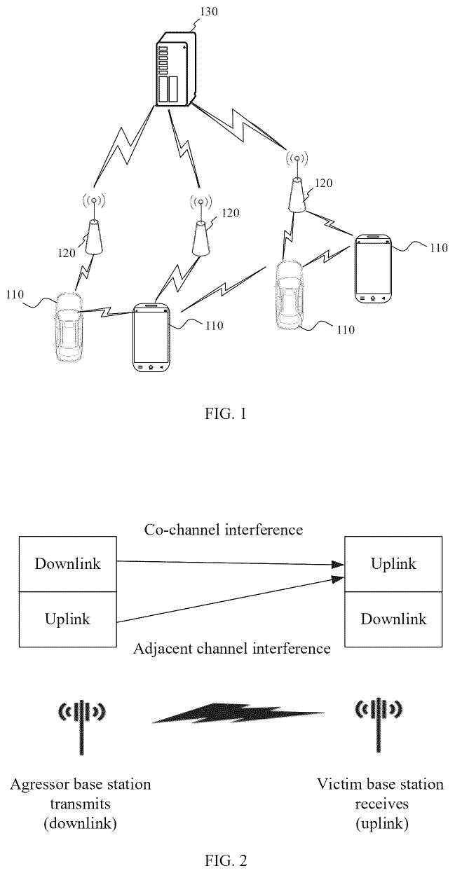

Referring to FIG. 1. FIG. 1 shows a schematic structural diagram of a wireless communication system provided by an embodiment of the present disclosure. As shown in FIG. 1, the wireless communication system is a communication system based on a mobile communication technology, and the wireless communication system may include several user devices 110 and several base stations 120.

The user device 110 may be a device that provides voice and/or data connectivity to a user. The user device 110 may communicate with one or more core networks through a radio access network (RAN). The user device 101 may be an Internet of Things user device, such as a sensor device, a mobile phone, and a computer having the Internet of Things user device, for example a fixed, portable, pocket, handheld, computer built-in, or vehicle-mounted apparatus. For example, the user device may be a station (STA), a subscriber unit, a subscriber station, a mobile station, a mobile table, a remote station, an access point, a remote terminal, an access terminal, a user terminal, a user agent, or user equipment. Altematively, the user device 110 may be a device of an unmanned aerial vehicle. Alternatively, the user device 110 may also be a vehicle-mounted device, for example, a vehicle computer having a wireless communication function, or a wireless user device externally connected to a vehicle computer. Alternatively, the user device 110 may also be a roadside device, for example, a street lamp, a signal light, other roadside device, etc., having a wireless communication function.

The base station 120 may be a network-side device in the wireless communication system. The wireless communication system may be a 4th generation mobile communication (4G) system, also referred to as a long term evolution (LTE) system; or the wireless communication system may also be a 5G system, also referred to as a new radio (NR, or air interface) system or a 5G NR system. Alternatively, the wireless communication system may be a next generation system of the 5G system. The access network in the 5G system may be referred to as an NG-RAN (new generation-radio access network).

The base station 120 may be an evolved Node B (eNB) used in the 4G system. Alternatively, the base station 120 may also be a base station using a centralized distributed architecture (gNB) in the 5G system. When the base station 120 uses the centralized distributed architecture, the base station 120 usually includes a central unit (CU) and at least two distributed units (DUs) The central unit is provided with a protocol stack of a packet data convergence protocol (PDCP) layer, a radio link control (RLC) protocol layer, and a media access control (MAC) layer; and the distributed units are provided with a protocol stack of a physical (PHY) layer. The specific implementation of the base station 120 is not limited in the embodiments of the present disclosure.

A wireless connection may be established between the base station 120 and the user device 110 through a wireless air interface. In different implementations, the wireless air interface is a wireless air interface based on a 4th generation mobile communication network technology (4G) standard; or the wireless air interface is a wireless air interface based on a 5th generation mobile communication network technology (5G) standard, for example, the wireless air interface is a new radio; or the wireless air interface may also be a wireless air interface based on a next generation mobile communication network technology standard of the 5G.

In some embodiments, an E2E (end to end) connection may also be established between the user devices 110. For example, there are scenarios, such as V2V (vehicle to vehicle) communication. V2I (vehicle to infrastructure) communication, V2P (vehicle to pedestrian) communication, etc., in V2X (vehicle to everything) communication.

Herein, the above user device may be considered as a terminal device in the following embodiments.

In some embodiments, the above wireless communication system may further include a network management device 130.

The several base stations 120 are respectively connected to the network management device 130. The network management device 130 may be a core network device in the wireless communication system. For example, the network management device 130 may be a mobility management entity (MME) in an evolved packet core (EPC) network. Alternatively, the network management device may also be another core network device, for example, a serving gateway (SGW), a public data network gateway (PGW), a policy and charging rules function (PCRF) unit, a home subscriber server (HSS), etc. An implementation form of the network management device 130 is not limited in the embodiments of the present disclosure.

For ease of understanding by those skilled in the art, the embodiments of the present disclosure list a plurality of implementations to clearly describe technical solutions of the embodiments of the present disclosure. Of course, those skilled in the art may understand that the plurality of embodiments provided by the embodiments of the present disclosure may be executed separately, or may be executed together with methods of other embodiments in embodiments of the present disclosure, or may be executed separately or together with some methods in other related technologies, which is not limited in the embodiments of the present disclosure.

In order to better understand technical solutions described in any one of embodiments of the present disclosure, an application scenario in the related art is described firstly.

In an embodiment, for the full duplex transmission manner, the enhancement is executed only on the base station side, while the half duplex transmission manner is only still supported on the terminal side. The reason is that: if sending and receiving are simultaneously implemented on one carrier, a sending end and a receiving end need to be able to better suppress cross-slot interference and self-interference. The cross-slot interference may be measured, avoided, and eliminated through a certain mechanism. For the self-interference, a device needs to have a relatively high transmitting-receiving isolation degree, thereby achieving a relatively strong self-interference suppression capability. Generally speaking, the full duplex transmission manner may lead to an improvement of the throughput, a reduction of the transmission delay (especially uplink transmission), and an enhancement of the uplink coverage range. To achieve the above objective, the uplink transmission needs to be scheduled in a downlink region of a time division duplex (TDD) frequency band or a downlink spectrum of a frequency division duplex (FDD) frequency band. According to related protocols, the terminal does not send uplink data in a downlink slot. Therefore, the base station needs to indicate a frequency domain range that may be used by the terminal for the uplink transmission in the downlink slot. However, there is no explicit method at present to indicate a resource used for the uplink data transmission in the downlink slot.

In an embodiment, data may be received and sent simultaneously in a slot. In order to reduce the impact on terminal complexity and radio frequency as much as possible, the research on the duplex mode enhancement may be limited to the base station side, that is, the full duplex is supported only on the base station side.

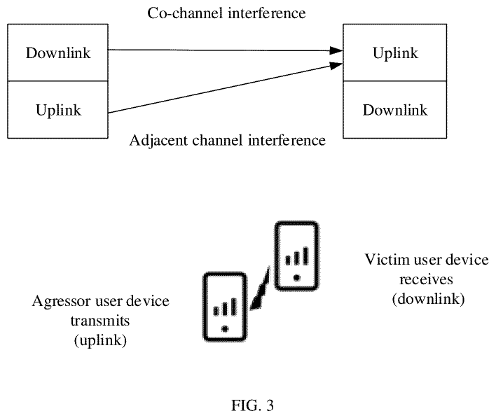

For example, FIG. 2 shows a common-channel interference (or co-channel interference) between base stations, and FIG. 3 shows the common-channel interference between terminals.

In some embodiments, there are mainly the following three full duplex solutions on the base station side:

a non-overlapping sub-band, that is, uplink data and downlink data are transmitted on different sub-bands, and there is no overlap between the sub-bands in the frequency domain;

a partial overlapping sub-band, that is, the uplink data and downlink data are transmitted on different sub-bands, and there is partial overlap between the sub-bands in the frequency domain; and

a shared spectrum full duplex, that is, the uplink data and downlink data may be transmitted on completely overlapping frequency domain resources.

In an embodiment, the terminal or the base station obtains frame structure information with high layer signaling or physical layer signaling, where the frame structure information indicates transmission direction information of a target transmission unit. The transmission direction information may be “D” (indicating that the transmission direction of the target transmission unit is a downlink transmission direction). “U” (indicating that the transmission direction of the target transmission unit is an uplink transmission direction), and “F” (indicating that the transmission direction of the target transmission unit is neither the uplink transmission direction nor the downlink transmission direction; or indicating that the transmission direction of the target transmission unit may be either the uplink transmission direction or the downlink transmission direction).

Transmission direction information between different transmission units may change dynamically, and therefore, it is necessary to clarify how to determine the transmission direction on the target transmission unit.

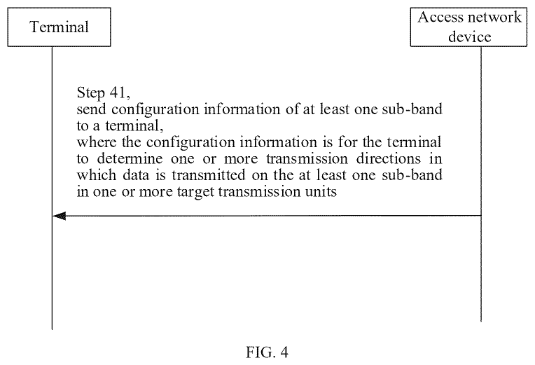

As shown in FIG. 4, a method for determining transmission direction is provided in this embodiment. The method is executed by an access network device, and the method includes the following step 41.

At step 41, configuration information of at least one sub-band is sent to a terminal.

The configuration information is for the terminal to determine one or more transmission directions in which data is transmitted on the at least one sub-band in one or more target transmission units.

Herein, the terminal involved in the present disclosure may be, but is not limited to, a mobile phone, a wearable device, a vehicle-mounted terminal, a road side unit (RSU), a smart home terminal, an industrial sensing device, a medical device, etc. In some embodiments, the terminal may be a redcap terminal or a new radio (NR) terminal of a preset version (for example, an R17 NR terminal).

The access network device involved in the present disclosure may be one of various types of base stations, for example, a base station in a third generation (3G) mobile communication network, a base station in a fourth generation (4G) mobile communication network, a base station in a fifth generation (5G) mobile communication network, or another evolved base station.

It should be noted that the frequency resource may be divided into a plurality of sub-bands. A same target transmission unit may correspond to a plurality of sub-bands in the frequency domain. Transmission in different transmission directions may be executed on each of the sub-bands.

For example, the target transmission unit corresponds to a first sub-band, a second sub-band, and a third sub-band in the frequency domain, and then the uplink transmission may be executed on the first sub-band, the downlink transmission may be executed on the second sub-band, and a transmission direction on the third sub-band may be uncertain.

The target transmission unit may be a transmission unit in a time domain. For example, the target transmission unit includes one or more of a symbol, a slot, a subframe, or a radio frame, but the target transmission unit is not limited to the above examples.

In an embodiment, the access network device sends the configuration information of the at least one sub-band to the terminal; where the configuration information is for the terminal to determine the one or more transmission directions in which the data is transmitted on the at least one sub-band in the one or more target transmission units. After the terminal receives the configuration information sent by the access network device, the terminal determines, according to the configuration information, the transmission direction in which the data is transmitted on the sub-band in the target transmission unit. The terminal transmits the data based on the transmission direction.

In an embodiment, the access network device sends first configuration information of the at least one sub-band to the terminal, where the first configuration information is for indicating that one or more transmission directions in which data is transmitted on a target sub-band in one or more target transmission units are one or more downlink transmission directions. After the terminal receives the first configuration information sent by the access network device, the terminal determines, according to the first configuration information, the transmission direction in which the data is transmitted on the target sub-band in the target transmission unit, and transmits downlink data on the target sub-band.

In an embodiment, the access network device sends second configuration information of the at least one sub-band to the terminal, where the second configuration information is for indicating that one or more transmission directions in which data is transmitted on a target sub-band in one or more target transmission units are one or more uplink transmission directions. After the terminal receives the second configuration information sent by the access network device, the terminal determines, according to the second configuration information, the transmission direction in which the data is transmitted on the target sub-band in the target transmission unit, and transmits uplink data on the target sub-band.

In an embodiment, the access network device sends third configuration information of the at least one sub-band to the terminal, where the third configuration information is for indicating that one or more transmission directions in which data is transmitted on a target sub-band in one or more target transmission units are one or more uncertain transmission directions. After the terminal receives the third configuration information sent by the access network device, the terminal determines, according to the third configuration information and a requirement that the terminal needs to transmit the downlink data, that the transmission direction in which the data is transmitted on the target sub-band in the target transmission unit is a downlink transmission direction, and transmits the downlink data on the target sub-band, or determines, according to the third configuration information and a requirement that the terminal needs to transmit the uplink data, that the transmission direction in which the data is transmitted on the target sub-band in the target transmission unit is an uplink transmission direction, and transmits the uplink data on the target sub-band.

In an embodiment, the access network device sends the configuration information of the at least one sub-band to the terminal with a system message; where the configuration information is for the terminal to determine the one or more transmission directions in which the data is transmitted on the at least one sub-band in the one or more target transmission units.

In an embodiment, the access network device sends the configuration information of the at least one sub-band to the terminal with physical layer signaling; where the configuration information is for the terminal to determine the one or more transmission directions in which the data is transmitted on the at least one sub-band in the one or more target transmission units.

In an embodiment, the configuration information is sent to the terminal with high layer signaling.

In an embodiment, the access network device sends the configuration information of the at least one sub-band to the terminal with common downlink control information (DCI); where the configuration information is for the terminal to determine the one or more transmission directions in which the data is transmitted on the at least one sub-band in the one or more target transmission units.

In an embodiment, the access network device sends the configuration information of the at least one sub-band to the terminal with terminal specific DCI; where the configuration information is for the terminal to determine the one or more transmission directions in which the data is transmitted on the at least one sub-band in the one or more target transmission units.

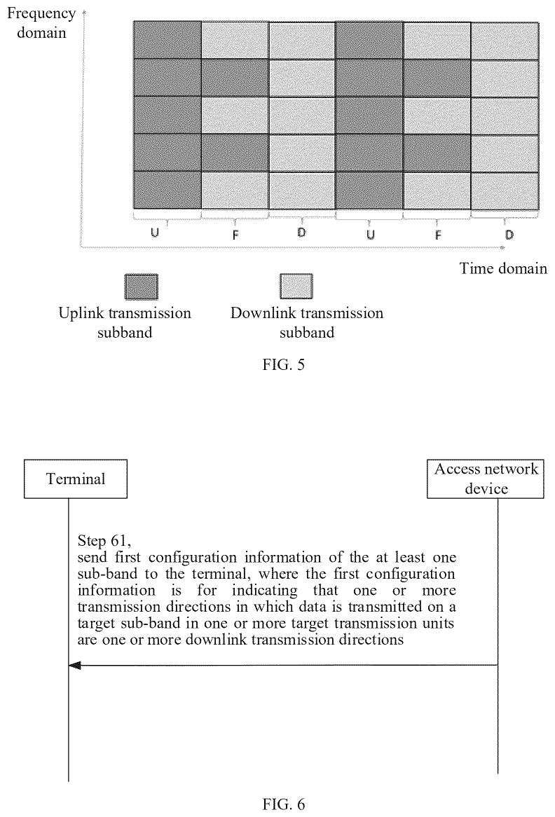

In an embodiment, referring to FIG. 5, the frequency domain resource is divided into 5 sub-bands for the target transmission unit (for example, a slot). If the target transmission unit is the slot, each of sub-bands for a first slot and a fourth slot may be configured for uplink transmission, each of sub-bands for a third slot and a sixth slot may be configured for downlink transmission, and sub-bands for a second slot and a fifth slot may be configured for the uplink transmission or the downlink transmission, or transmission in an uncertain direction, that is, a transmission direction is uncertain.

It should be noted that the configuration information may carry different indicators. For example, when the sub-bands for the first slot are configured for uplink transmission, a corresponding indicator is “U”; and after the terminal receives the configuration information carrying the indicator “U”, the terminal determines that the transmission directions in the first slot are only the uplink transmission (the corresponding sub-bands are uplink transmission sub-bands). When the sub-bands for the second slot are configured for the transmission in the uncertain direction, a corresponding indicator is “F”; and after the terminal receives the configuration information carrying the indicator “F”, the terminal determines that flexible transmission may be executed in the transmission directions in the second slot, which may be configured as the uplink transmission or the downlink transmission. It should be noted that the transmission directions may be that the uplink transmission can only be executed for a part of the sub-bands and the downlink transmission can only be executed for the other part of the sub-bands. When the sub-bands for the third slot are configured for the downlink transmission, a corresponding indicator is “D”; and after the terminal receives the configuration information carrying the indicator “D”, the terminal determines that the transmission directions in the third slot are only the downlink transmission (the corresponding sub-bands are downlink transmission sub-bands).

It should be noted that the identifiers “U”, “F”, and “D” are merely examples, and new definitions may be made according to a specific transmission direction scenario, not limited to the above identifiers and/or the above three identifiers. In another description, the identifier may also be understood as direction indication information. The identifier may be indicated by 1 or 2 bits.

In an embodiment, the configuration information may be configured in units of all sub-bands for the target transmission unit. For example, the configuration information carries “UDUDF”, which indicates that all sub-bands for the first slot and the third slot are for the uplink transmission, all sub-bands for the second slot and the fourth slot are for the downlink transmission, and sub-bands for the fifth slot are for the transmission in the uncertain direction.

In an embodiment, the configuration information may alternatively be configured in units of each of the sub-bands for the target transmission unit. For example, the configuration information carries “UDU”, “FDU”, and “UUD”, which indicate that: the first sub-band and the third sub-band for the first slot are for the uplink transmission and the second sub-band for the first slot is for the downlink transmission; the first sub-band for the second slot is for the transmission in the uncertain direction, the second sub-band for the second slot is for the downlink transmission, and the third sub-band for the second slot is for the uplink transmission; and the first sub-band and the second sub-band for the third slot are for the uplink transmission, and the third sub-band for the third slot is for the downlink transmission.

In an embodiment of the present disclosure, the access network device sends the configuration information of the at least one sub-band to the terminal; where the configuration information is for the terminal to determine the one or more transmission directions in which the data is transmitted on the at least one sub-band in the one or more target transmission units. Herein, because the access network device sends the configuration information of the at least one sub-band to the terminal, after the terminal receives the configuration information, the terminal may determine, according to the configuration information, the one or more transmission directions in which the data is transmitted on the at least one sub-band in the one or more target transmission units. Compared with the situation of the transmission direction in which the data is transmitted on the sub-band in the target transmission unit cannot be determined, the method can make the data transmission more reliable.

It should be noted that those skilled in the art may understand that the method provided in the embodiments of the present disclosure may be executed separately, or may be executed together with some methods in the embodiments of the present disclosure or some methods in related technologies.

In an embodiment, the target transmission units include one or more of: a symbol, a slot, a subframe, or a radio frame.

In an embodiment, the configuration information includes one of:

first configuration information, for indicating that one or more transmission directions in which data is transmitted on a target sub-band in one or more target transmission units are one or more downlink transmission directions;

second configuration information, for indicating that one or more transmission directions in which data is transmitted on a target sub-band in one or more target transmission units are one or more uplink transmission directions; or

third configuration information, for indicating that one or more transmission directions in which data is transmitted on a target sub-band in one or more target transmission units are one or more uncertain transmission directions.

As shown in FIG. 6, a method for determining transmission direction is provided in this embodiment. The method is executed by an access network device, and the method includes the following step 61.

At step 61, first configuration information of the at least one sub-band is sent to the terminal, where the first configuration information is for indicating that one or more transmission directions in which data is transmitted on a target sub-band in one or more target transmission units are one or more downlink transmission directions.

In an embodiment, the access network device sends first configuration information of the at least one sub-band to the terminal, where the first configuration information is for indicating that one or more transmission directions in which data is transmitted on a target sub-band in one or more target transmission units are one or more downlink transmission directions. After the terminal receives the first configuration information sent by the access network device, the terminal determines, according to the first configuration information, the transmission direction in which the data is transmitted on the target sub-band in the target transmission unit, and transmits downlink data on the target sub-band.

In an embodiment, the access network device sends first configuration information of the at least one sub-band to the terminal with a system message, where the first configuration information is for indicating that one or more transmission directions in which data is transmitted on a target sub-band in one or more target transmission units are one or more downlink transmission directions.

In an embodiment, the access network device sends first configuration information of the at least one sub-band to the terminal with common DCI, where the first configuration information is for indicating that one or more transmission directions in which data is transmitted on a target sub-band in one or more target transmission units are one or more downlink transmission directions.

In an embodiment, the access network device sends first configuration information of the at least one sub-band to the terminal with terminal specific DCI, where the first configuration information is for indicating that one or more transmission directions in which data is transmitted on a target sub-band in one or more target transmission units are one or more downlink transmission directions.

It should be noted that those skilled in the art may understand that the method provided in the embodiments of the present disclosure may be executed separately, or may be executed together with some methods in the embodiments of the present disclosure or some methods in related technologies.

As shown in FIG. 7, a method for determining transmission direction is provided in this embodiment. The method is executed by an access network device, and the method includes the following step 71.

At step 71, second configuration information of the at least one sub-band is sent to the terminal, where the second configuration information is for indicating that one or more transmission directions in which data is transmitted on a target sub-band in one or more target transmission units are one or more uplink transmission directions.

In an embodiment, the access network device sends second configuration information of the at least one sub-band to the terminal, where the second configuration information is for indicating that one or more transmission directions in which data is transmitted on a target sub-band in one or more target transmission units are one or more uplink transmission directions. After the terminal receives the second configuration information sent by the access network device, the terminal determines, according to the second configuration information, the transmission direction in which the data is transmitted on the target sub-band in the target transmission unit, and transmits uplink data on the target sub-band.

In an embodiment, the access network device sends second configuration information of the at least one sub-band to the terminal with a system message, where the second configuration information is for indicating that one or more transmission directions in which data is transmitted on a target sub-band in one or more target transmission units are one or more uplink transmission directions.

In an embodiment, the access network device sends second configuration information of the at least one sub-band to the terminal with common DCI, where the second configuration information is for indicating that one or more transmission directions in which data is transmitted on a target sub-band in one or more target transmission units are one or more uplink transmission directions.

In an embodiment, the access network device sends second configuration information of the at least one sub-band to the terminal with terminal specific DCI, where the second configuration information is for indicating that one or more transmission directions in which data is transmitted on a target sub-band in one or more target transmission units are one or more uplink transmission directions.

It should be noted that those skilled in the art may understand that the method provided in the embodiments of the present disclosure may be executed separately, or may be executed together with some methods in the embodiments of the present disclosure or some methods in related technologies.

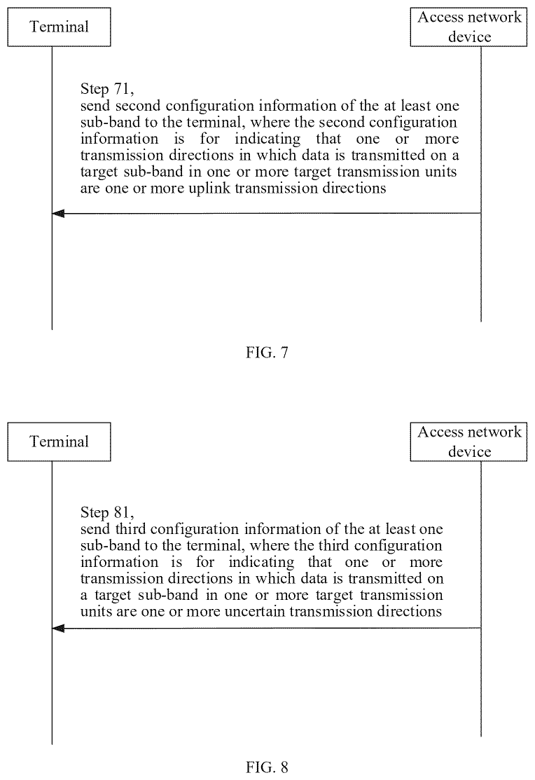

As shown in FIG. 8, a method for determining transmission direction is provided in this embodiment. The method is executed by an access network device, and the method includes the following step 81.

At step 81, third configuration information of the at least one sub-band is sent to the terminal, where the third configuration information is for indicating that one or more transmission directions in which data is transmitted on a target sub-band in one or more target transmission units are one or more uncertain transmission directions.

In an embodiment, the access network device sends third configuration information of the at least one sub-band to the terminal, where the third configuration information is for indicating that one or more transmission directions in which data is transmitted on a target sub-band in one or more target transmission units are one or more uncertain transmission directions. After the terminal receives the third configuration information sent by the access network device, the terminal determines, according to the third configuration information and a requirement that the terminal sends the downlink data, that the transmission direction in which the data is transmitted on the target sub-band in the target transmission unit is a downlink transmission direction, and transmits the downlink data on the target sub-band, or determines, according to the third configuration information and a requirement that the terminal sends the uplink data, that the transmission direction in which the data is transmitted on the target sub-band in the target transmission unit is an uplink transmission direction, and transmits the uplink data on the target sub-band.

In an embodiment, the access network device sends third configuration information of the at least one sub-band to the terminal with a system message, where the third configuration information is for indicating that one or more transmission directions in which data is transmitted on a target sub-band in one or more target transmission units are one or more uncertain transmission directions.

In an embodiment, the access network device sends third configuration information of the at least one sub-band to the terminal with common DCI, where the third configuration information is for indicating that one or more transmission directions in which data is transmitted on a target sub-band in one or more target transmission units are one or more uncertain transmission directions.

In an embodiment, the access network device sends third configuration information of the at least one sub-band to the terminal with terminal specific DCI, where the third configuration information is for indicating that one or more transmission directions in which data is transmitted on a target sub-band in one or more target transmission units are one or more uncertain transmission directions.

It should be noted that those skilled in the art may understand that the method provided in the embodiments of the present disclosure may be executed separately, or may be executed together with some methods in the embodiments of the present disclosure or some methods in related technologies.

In an embodiment, the configuration information includes one or more of:

direction indication information, for indicating the transmission direction; or

sub-band configuration information, for indicating the number of the at least one sub-band and/or a frequency of the at least one sub-band.

The transmission direction may be one of a downlink transmission direction, an uplink transmission direction, or an uncertain transmission direction.

In some embodiments, if the transmission direction is a downlink transmission direction, the configuration information is the first configuration information; if the transmission direction is an uplink transmission direction, the configuration information is the second configuration information; and if the transmission direction is an uncertain transmission direction, the configuration information is the third configuration information.

As shown in FIG. 9, a method for determining transmission direction is provided in this embodiment. The method is executed by an access network device, and the method includes the following step 91.

At step 91, configuration information of at least one sub-band is sent to a terminal.

The configuration information is for the terminal to determine one or more transmission directions in which data is transmitted on the at least one sub-band in one or more target transmission units. The configuration information includes one or more of:

direction indication information, for indicating the transmission direction; or

sub-band configuration information, for indicating the number of the at least one sub-band and/or a frequency of the at least one sub-band.

In an embodiment, the access network device sends configuration information of at least one sub-band to the terminal, where the configuration information is for the terminal to determine one or more transmission directions in which data is transmitted on the at least one sub-band in one or more target transmission units, and the configuration information includes one or more of: direction indication information, for indicating the transmission direction; or sub-band configuration information, for indicating the number of the at least one sub-band and/or the frequency of the at least one sub-band. After the terminal receives the configuration information sent by the access network device, the terminal determines, according to the configuration information, the transmission direction in which the data is transmitted on the sub-band in the target transmission unit. The terminal transmits the data based on the transmission direction.

It should be noted that those skilled in the art may understand that the method provided in the embodiments of the present disclosure may be executed separately, or may be executed together with some methods in the embodiments of the present disclosure or some methods in related technologies.

In an embodiment, the configuration information includes:

available time information, for indicating an effective duration of the configuration information, and/or for indicating an effective time of the configuration information.

It should be noted that the effective duration may correspond to a time period, for example, 1 hour. The effective time may correspond to two moments, for example, a start moment and an end moment. For example, the start moment is 2 o'clock, and the end moment is 3 o'clock. The effective time may also correspond to a moment and a time period, for example, a start moment and a duration. For example, the start moment is 2 o'clock, and the duration is 1 hour.

In an embodiment, when the configuration information is effective, the terminal may suspend obtaining the system message.

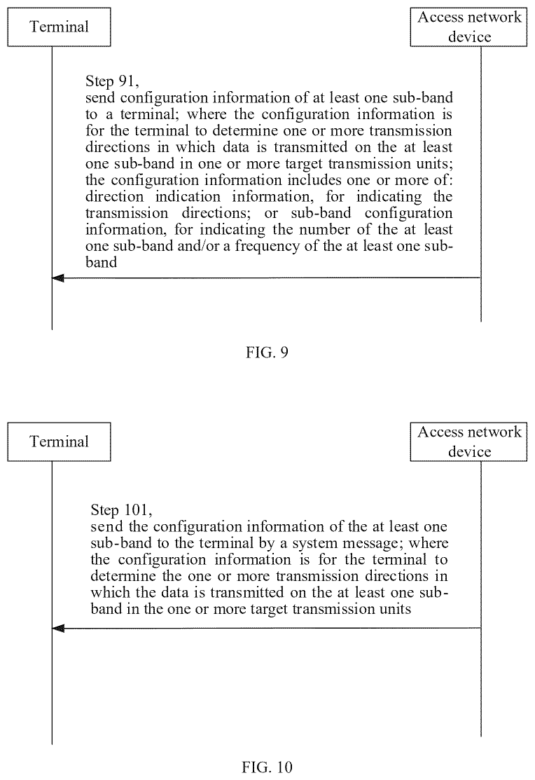

As shown in FIG. 10, a method for determining transmission direction is provided in this embodiment. The method is executed by an access network device, and the method includes the following step 101.

At step 101, the configuration information of the at least one sub-band is sent to the terminal with a system message; where the configuration information is for the terminal to determine the one or more transmission directions in which the data is transmitted on the at least one sub-band in the one or more target transmission units.

In an embodiment, the access network device sends the configuration information of the sub-band to the terminal with a system message; where the configuration information is for the terminal to determine the one or more transmission directions in which the data is transmitted on the at least one sub-band in the one or more target transmission units. The configuration information includes at least one of:

direction indication information, for indicating the transmission direction;

sub-band configuration information, for indicating the number of the at least one sub-band and/or a frequency of the at least one sub-band; or

available time information, for indicating a time at which the terminal does not need to obtain the system message, and/or for indicating an effective time of the configuration information.

It should be noted that the time may be indicated by a moment and/or duration. For example, the time ranges from a first second to a second second, or the time includes the first second and a duration of 1 second after the first second.

It should be noted that those skilled in the art may understand that the method provided in the embodiments of the present disclosure may be executed separately, or may be executed together with some methods in the embodiments of the present disclosure or some methods in related technologies.

As shown in FIG. 11, a method for determining transmission direction is provided in this embodiment. The method is executed by a terminal, and the method includes the following steps 111-112.

At step 111, configuration information of at least one sub-band sent by an access network device is received.

At step 112, one or more transmission directions in which data is transmitted on the at least one sub-band in one or more target transmission units are determined according to the configuration information

Herein, the terminal involved in the present disclosure may be, but is not limited to, a mobile phone, a wearable device, a vehicle-mounted terminal, a road side unit (RSU), a smart home terminal, an industrial sensing device, a medical device, etc. In some embodiments, the terminal may be a redcap terminal or a new radio (NR) terminal of a preset version (for example, an R17 NR terminal).

The access network device involved in the present disclosure may be one of various types of base stations, for example, a base station in a third generation (3G) mobile communication network, a base station in a fourth generation (4G) mobile communication network, a base station in a fifth generation (5G) mobile communication network, or another evolved base station.

It should be noted that the frequency resource may be divided into a plurality of sub-bands. A same target transmission unit may correspond to a plurality of sub-bands in the frequency domain. Transmission in different transmission directions may be executed on each of the sub-bands.

For example, the target transmission unit corresponds to a first sub-band, a second sub-band, and a third sub-band in the frequency domain, and then the uplink transmission may be executed on the first sub-band, the downlink transmission may be executed on the second sub-band, and a transmission direction on the third sub-band may be uncertain.

The target transmission unit may be a transmission unit in a time domain. The target transmission unit includes one or more of a symbol, a slot, a subframe, or a radio frame, but the target transmission unit is not limited to the above examples.

In an embodiment, the access network device sends the configuration information of the at least one sub-band to the terminal; where the configuration information is for the terminal to determine the one or more transmission directions in which the data is transmitted on the at least one sub-band in the one or more target transmission units. After the terminal receives the configuration information sent by the access network device, the terminal determines, according to the configuration information, the transmission direction in which data is transmitted on sub-band in the target transmission unit. The terminal transmits the data based on the transmission direction.

In an embodiment, the access network device sends first configuration information of the at least one sub-band to the terminal, where the first configuration information is for indicating that one or more transmission directions in which data is transmitted on a target sub-band in one or more target transmission units are one or more downlink transmission directions. After the terminal receives the first configuration information sent by the access network device.

the terminal determines, according to the first configuration information, the transmission direction in which the data is transmitted on the target sub-band in the target transmission unit, and transmits downlink data on the target sub-band.

In an embodiment, the access network device sends second configuration information of the at least one sub-band to the terminal, where the second configuration information is for indicating that one or more transmission directions in which data is transmitted on a target sub-band in one or more target transmission units are one or more uplink transmission directions. After the terminal receives the second configuration information sent by the access network device, the terminal determines, according to the second configuration information, the transmission direction in which the data is transmitted on the target sub-band in the target transmission unit, and transmits uplink data on the target sub-band.

In an embodiment, the access network device sends third configuration information of the at least one sub-band to the terminal, where the third configuration information is for indicating that one or more transmission directions in which data is transmitted on a target sub-band in one or more target transmission units are one or more uncertain transmission directions. After the terminal receives the third configuration information sent by the access network device, the terminal determines, according to the third configuration information and a requirement that the terminal needs to transmit the downlink data, that the transmission direction in which the data is transmitted on the target sub-band in the target transmission unit is a downlink transmission direction, and transmits the downlink data on the target sub-band, or determines, according to the third configuration information and a requirement that the terminal needs to transmit the uplink data, that the transmission direction in which the data is transmitted on the target sub-band in the target transmission unit is an uplink transmission direction, and transmits the uplink data on the target sub-band.

In an embodiment, the terminal receives the configuration information of the at least one sub-band sent by the access network device with a system message; where the configuration information is for the terminal to determine the one or more transmission directions in which the data is transmitted on the at least one sub-band in the one or more target transmission units.

In an embodiment, the terminal receives the configuration information of the at least one sub-band sent by the access network device with physical layer signaling; where the configuration information is for the terminal to determine the one or more transmission directions in which the data is transmitted on the at least one sub-band in the one or more target transmission units.

In an embodiment, the configuration information is sent to the terminal with high layer signaling.

In an embodiment, the terminal receives the configuration information of the at least one sub-band sent by the access network device with common DCI; where the configuration information is for the terminal to determine the one or more transmission directions in which the data is transmitted on the at least one sub-band in the one or more target transmission units.

In an embodiment, the terminal receives the configuration information of the at least one sub-band sent by the access network device with terminal specific DCI; where the configuration information is for the terminal to determine the one or more transmission directions in which the data is transmitted on the at least one sub-band in the one or more target transmission units.

In an embodiment, referring to FIG. 5 again, the frequency domain resource is divided into 5 sub-bands for the target transmission unit (for example, a slot). If the target transmission unit is the slot, each of sub-bands for a first slot and a fourth slot may be configured for uplink transmission, each of sub-bands for a third slot and a sixth slot may be configured for downlink transmission, and sub-bands for a second slot and a fifth slot may be configured for the uplink transmission or the downlink transmission, or transmission in an uncertain direction, that is, a transmission direction is uncertain.

It should be noted that the configuration information may carry different indicators. For example. when the sub-bands for the first slot are configured for uplink transmission, a corresponding indicator is “U”; and after the terminal receives the configuration information carrying the indicator “U”, the terminal determines that the transmission directions in the first slot are only the uplink transmission (the corresponding sub-bands are uplink transmission sub-bands). When the sub-bands for the second slot are configured for the transmission in the uncertain direction, a corresponding indicator is “F”; and after the terminal receives the configuration information carrying the indicator “F”, the terminal determines that flexible transmission may be executed in the transmission directions in the second slot, which may be configured as the uplink transmission or the downlink transmission. It should be noted that the transmission directions may be that the uplink transmission can only be executed for a part of the sub-bands and the downlink transmission can only be executed for the other part of the sub-bands. When the sub-bands for the third slot are configured for the downlink transmission, a corresponding indicator is “D”; and after the terminal receives the configuration information carrying the indicator “D”, the terminal determines that the transmission directions in the third slot are only the downlink transmission (the corresponding sub-bands are downlink transmission sub-bands).

It should be noted that the identifiers “U”, “F”, and “D” are merely examples, and new definitions may be made according to a specific transmission direction scenario, not limited to the above identifiers and/or the above three identifiers. In another description, the identifier may also be understood as direction indication information. The identifier may be indicated by 1 or 2 bits.

In an embodiment, the configuration information may be configured in units of all sub-bands for the target transmission unit. For example, the configuration information carries “UDUDF”, which indicates that all sub-bands for the first slot and the third slot are for the uplink transmission, all sub-bands for the second slot and the fourth slot are for the downlink transmission, and sub-bands for the fifth slot are for the transmission in the uncertain direction.

In an embodiment, the configuration information may alternatively be configured in units of each of the sub-bands for the target transmission unit. For example, the configuration information carries “UDU”, “FDU”, and “UUD”, which indicate that: the first sub-band and the third sub-band for the first slot are for the uplink transmission and the second sub-band for the first slot is for the downlink transmission; the first sub-band for the second slot is for the transmission in the uncertain direction, the second sub-band for the second slot is for the downlink transmission, and the third sub-band for the second slot is for the uplink transmission; and the first sub-band and the second sub-band for the third slot are for the uplink transmission. and the third sub-band for the third slot is for the downlink transmission.

It should be noted that those skilled in the art may understand that the method provided in the embodiments of the present disclosure may be executed separately, or may be executed together with some methods in the embodiments of the present disclosure or some methods in related technologies.

In an embodiment, the target transmission units include one or more of: a symbol, a slot, a subframe, or a radio frame.

In an embodiment, the configuration information includes one of:

first configuration information, for indicating that one or more transmission directions in which data is transmitted on a target sub-band in one or more target transmission units are one or more downlink transmission directions;

second configuration information, for indicating that one or more transmission directions in which data is transmitted on a target sub-band in one or more target transmission units are one or more uplink transmission directions; or

third configuration information, for indicating that one or more transmission directions in which data is transmitted on a target sub-band in one or more target transmission units are one or more uncertain transmission directions.

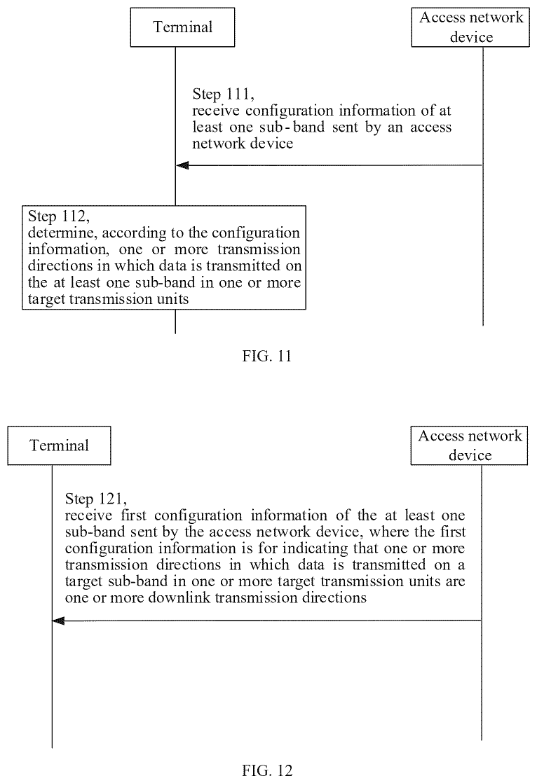

As shown in FIG. 12, a method for determining transmission direction is provided in this embodiment. The method is executed by a terminal, and the method includes the following step 121.

At step 121, first configuration information of the at least one sub-band sent by the access network device is received, where the first configuration information is for indicating that one or more transmission directions in which data is transmitted on a target sub-band in one or more target transmission units are one or more downlink transmission directions.

In an embodiment, the terminal receives the first configuration information of the at least one sub-band sent by the access network device, where the first configuration information is for indicating that one or more transmission directions in which data is transmitted on a target sub-band in one or more target transmission units are one or more downlink transmission directions. After the terminal receives the first configuration information sent by the access network device, the terminal determines, according to the first configuration information, the transmission direction in which the data is transmitted on the target sub-band in the target transmission unit, and transmits downlink data on the target sub-band.

In an embodiment, the terminal receives the first configuration information of the at least one sub-band sent by the access network device with a system message, where the first configuration information is for indicating that one or more transmission directions in which data is transmitted on a target sub-band in one or more target transmission units are one or more downlink transmission directions.

In an embodiment, the terminal receives the first configuration information of the at least one sub-band sent by the access network device with common DCI, where the first configuration information is for indicating that one or more transmission directions in which data is transmitted on a target sub-band in one or more target transmission units are one or more downlink transmission directions.

In an embodiment, the terminal receives the first configuration information of the at least one sub-band sent by the access network device with terminal specific DCI, where the first configuration information is for indicating that one or more transmission directions in which data is transmitted on a target sub-band in one or more target transmission units are one or more downlink transmission directions.

It should be noted that those skilled in the art may understand that the method provided in the embodiments of the present disclosure may be executed separately, or may be executed together with some methods in the embodiments of the present disclosure or some methods in related technologies.

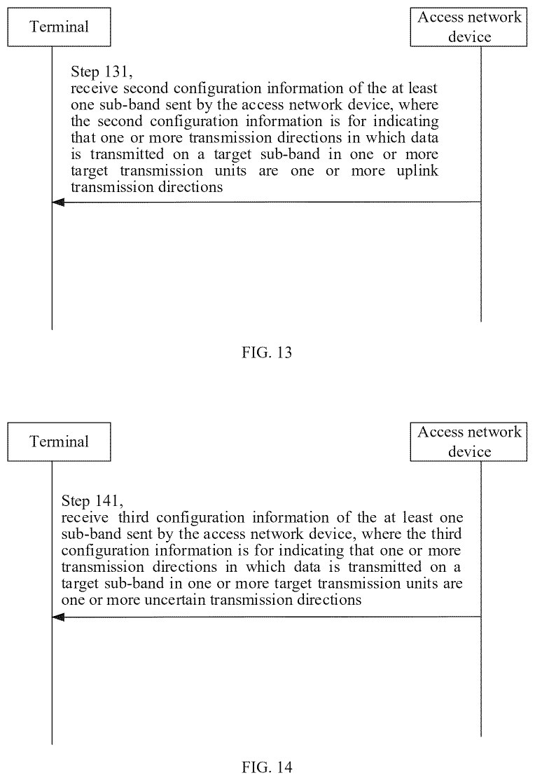

As shown in FIG. 13, a method for determining transmission direction is provided in this embodiment. The method is executed by a terminal, and the method includes the following step 131.

At step 131, second configuration information of the at least one sub-band sent by the access network device is received, where the second configuration information is for indicating that one or more transmission directions in which data is transmitted on a target sub-band in one or more target transmission units are one or more uplink transmission directions.

In an embodiment, the terminal receives the second configuration information of the at least one sub-band sent by the access network device, where the second configuration information is for indicating that one or more transmission directions in which data is transmitted on a target sub-band in one or more target transmission units are one or more uplink transmission directions. After the terminal receives the second configuration information sent by the access network device, the terminal determines, according to the second configuration information, the transmission direction in which the data is transmitted on the target sub-band in the target transmission unit, and transmits uplink data on the target sub-band.

In an embodiment, the terminal receives the second configuration information of the at least one sub-band sent by the access network device with a system message, where the second configuration information is for indicating that one or more transmission directions in which data is transmitted on a target sub-band in one or more target transmission units are one or more uplink transmission directions.

In an embodiment, the terminal receives the second configuration information of the at least one sub-band sent by the access network device with common DCI, where the second configuration information is for indicating that one or more transmission directions in which data is transmitted on a target sub-band in one or more target transmission units are one or more uplink transmission directions

In an embodiment, the terminal receives the second configuration information of the at least one sub-band sent by the access network device with terminal specific DCI, where the second configuration information is for indicating that one or more transmission directions in which data is transmitted on a target sub-band in one or more target transmission units are one or more uplink transmission directions.

It should be noted that those skilled in the art may understand that the method provided in the embodiments of the present disclosure may be executed separately, or may be executed together with some methods in the embodiments of the present disclosure or some methods in related technologies.

As shown in FIG. 14, a method for determining transmission direction is provided in this embodiment. The method is executed by a terminal, and the method includes the following step 141.

At step 141, third configuration information of the at least one sub-band sent by the access network device is received, where the third configuration information is for indicating that one or more transmission directions in which data is transmitted on a target sub-band in one or more target transmission units are one or more uncertain transmission directions.

In an embodiment, the terminal receives the third configuration information of the at least one sub-band sent by the access network device, where the third configuration information is for indicating that one or more transmission directions in which data is transmitted on a target sub-band in one or more target transmission units are one or more uncertain transmission directions. After the terminal receives the third configuration information sent by the access network device, the terminal determines, according to the third configuration information and a requirement that the terminal transmits the downlink data, that the transmission direction in which the data is transmitted on the target sub-band in the target transmission unit is a downlink transmission direction, and transmits the downlink data on the target sub-band, or determines, according to the third configuration information and a requirement that the terminal transmits the uplink data, that the transmission direction in which the data is transmitted on the target sub-band in the target transmission unit is an uplink transmission direction, and transmits the uplink data on the target sub-band.

In an embodiment, the terminal receives the third configuration information of the at least one sub-band sent by the access network device with a system message, where the third configuration information is for indicating that one or more transmission directions in which data is transmitted on a target sub-band in one or more target transmission units are one or more uncertain transmission directions.

In an embodiment, the terminal receives the third configuration information of the at least one sub-band sent by the access network device with common DCI, where the third configuration information is for indicating that one or more transmission directions in which data is transmitted on a target sub-band in one or more target transmission units are one or more uncertain transmission directions.

In an embodiment, the terminal receives the third configuration information of the at least one sub-band sent by the access network device with terminal specific DCI, where the third configuration information is for indicating that one or more transmission directions in which data is transmitted on a target sub-band in one or more target transmission units are one or more uncertain transmission directions.

It should be noted that those skilled in the art may understand that the method provided in the embodiments of the present disclosure may be executed separately, or may be executed together with some methods in the embodiments of the present disclosure or some methods in related technologies.

In an embodiment, the configuration information includes one or more of:

direction indication information, for indicating the transmission direction;

sub-band configuration information, for indicating the number of the at least one sub-band and/or a frequency of the at least one sub-band.

The transmission direction may be one of a downlink transmission direction, an uplink transmission direction, or an uncertain transmission direction.

In some embodiments, if the transmission direction is a downlink transmission direction, the configuration information is the first configuration information; if the transmission direction is an uplink transmission direction, the configuration information is the second configuration information; and if the transmission direction is an uncertain transmission direction, the configuration information is the third configuration information.

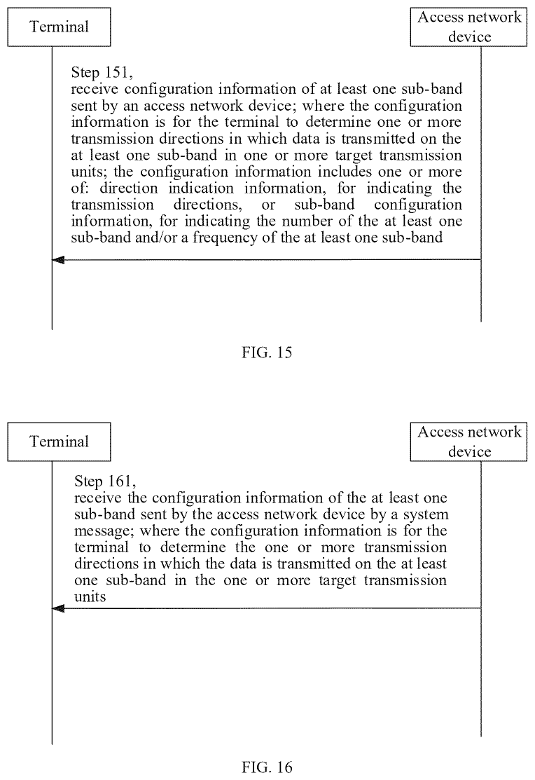

As shown in FIG. 15, a method for determining transmission direction is provided in this embodiment. The method is executed by a terminal, and the method includes the following step 151.

At step 151, configuration information of at least one sub-band sent by an access network device is received.

The configuration information is for the terminal to determine one or more transmission directions in which data is transmitted on the at least one sub-band in one or more target transmission units. The configuration information includes one or more of:

direction indication information, for indicating the transmission direction; or

sub-band configuration information, for indicating the number of the at least one sub-band and/or a frequency of the at least one sub-band.

In an embodiment, the access network device sends configuration information of at least one sub-band to the terminal, where the configuration information is for the terminal to determine one or more transmission directions in which data is transmitted on the at least one sub-band in one or more target transmission units, and the configuration information includes one or more of: direction indication information, for indicating the transmission direction; or sub-band configuration information, for indicating the number of the at least one sub-band and/or the frequency of the at least one sub-band. After the terminal receives the configuration information sent by the access network device, the terminal determines, according to the configuration information, the transmission direction in which the data is transmitted on the sub-band in the target transmission unit. The terminal transmits the data based on the transmission direction.

It should be noted that those skilled in the art may understand that the method provided in the embodiments of the present disclosure may be executed separately, or may be executed together with some methods in the embodiments of the present disclosure or some methods in related technologies.

As shown in FIG. 16, a method for determining transmission direction is provided in this embodiment. The method is executed by a terminal, and the method includes the following step 161.

At step 161, the configuration information of the at least one sub-band sent by the access network device is received with a system message; where the configuration information is for the terminal to determine the one or more transmission directions in which the data is transmitted on the at least one sub-band in the one or more target transmission units.

In an embodiment, the terminal receives the configuration information of the sub-band sent by the access network device with a system message; where the configuration information is for the terminal to determine the one or more transmission directions in which the data is transmitted on the at least one sub-band in the one or more target transmission units. The configuration information includes at least one of:

direction indication information, for indicating the transmission direction;

sub-band configuration information, for indicating the number of the at least one sub-band and/or a frequency of the at least one sub-band; or

available time information, for indicating a time at which the terminal does not need to obtain the system message, and/or for indicating an effective time of the configuration information.

It should be noted that the time may be indicated by a moment and/or duration. For example, the time ranges from a first second to a second second, or the time includes the first second and a duration of 1 second after the first second.

It should be noted that those skilled in the art may understand that the method provided in the embodiments of the present disclosure may be executed separately, or may be executed together with some methods in the embodiments of the present disclosure or some methods in related technologies.

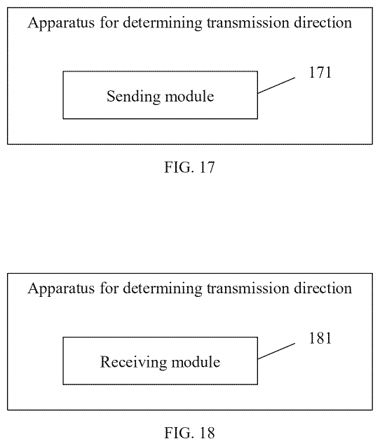

As shown in FIG. 17, an apparatus for determining transmission direction is provided in this embodiment The apparatus includes:

a sending module 171, configured to send configuration information of at least one sub-band to a terminal;

where the configuration information is for the terminal to determine one or more transmission directions in which data is transmitted on the at least one sub-band in one or more target transmission units.

It should be noted that those skilled in the art may understand that the method provided in the embodiments of the present disclosure may be executed separately, or may be executed together with some methods in the embodiments of the present disclosure or some methods in related technologies.

As shown in FIG. 18, an apparatus for determining transmission direction is provided in the embodiment of the present disclosure. The apparatus includes:

a receiving module 181, configured to receive configuration information of at least one sub-band sent by an access network device; and determine, according to the configuration information, one or more transmission directions in which data is transmitted on the at least one sub-band in one or more target transmission units.

It should be noted that those skilled in the art may understand that the method provided in the embodiments of the present disclosure may be executed separately, or may be executed together with some methods in the embodiments of the present disclosure or some methods in related technologies.

An embodiment of the present disclosure provides a communication device, including;

a processor; and

a memory configured to store processor executable instructions;

where the processor is configured to implement, when executing the executable instructions, the method applied to any embodiment of the present disclosure.

The processor may include various types of storage mediums. The storage mediums are non-transitory computer storage mediums, and can continue to memorize information stored in the storage mediums after the communication device is powered off.

The processor may be connected to the memory by a bus, etc., and is configured to read an executable program stored in the memory.

An embodiment of the present disclosure further provides a computer storage medium, storing a computer executable program. When the executable program is executed by a processor, the method of any embodiment of the present disclosure is implemented.

The specific manners in which each of the modules of the apparatus in the above embodiments executes operations have been described in detail in the embodiments related to the method. and will not be explained here in detail.

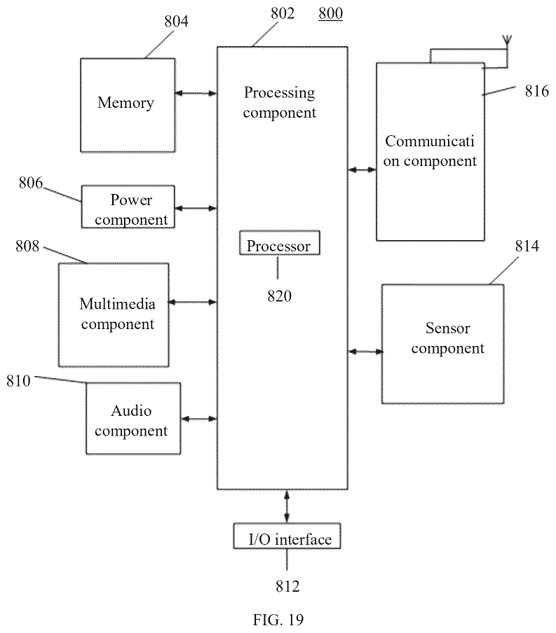

As shown in FIG. 19, an embodiment of the present disclosure provides a structure of a terminal.

Referring to FIG. 19, this embodiment provides a terminal 800. The terminal may be specifically a mobile phone, a computer, a digital broadcast terminal, a message transceiving device, a game console, a tablet device, a medical device, a fitness device, a personal digital assistant, etc.

Referring to FIG. 19. the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the terminal 800, such as operations associated with display, phone calls, data communication, camera operations, and recording operations. The processing component 802 may include one or more processors 820 to execute instructions to complete all or part of the steps in the above methods. Additionally, the processing component 802 may include one or more modules to facilitate interaction between the processing component 802 and other components For example, the processing component 802 may include a multimedia module to facilitate interaction between the multimedia component 808 and the processing component 802.

The memory 804 is configured to store various types of data to support operations of the terminal 800. Examples of such data include instructions, contact data, phonebook data, messages, pictures, videos, etc., for any application program or method operating on the terminal 800. The memory 804 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides power to various components of the terminal 800. The power component 806 may include a power supply management system, one or more power supplies, and other components that are associated with generating, managing, and distributing power for the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen, to receive an input signal from the user. The touch panel includes one or more touch sensors to sense the touch, the slide, and the gesture on the touch panel. The touch sensor may not only sense the boundary of the touch or slide action, but also detect the duration and pressure related to the touch or slide operation. In some embodiments, the multimedia component 808 includes a front facing camera and/or a rear facing camera. When the terminal 800 is in an operation mode, such as a shooting mode or a video mode, the front facing camera and/or the rear facing camera may receive external multimedia data. Each of the front facing camera and rear facing camera may be a fixed optical lens system or has a focal length and an optical zoom capability.

The audio component 810 is configured to output and/or input audio signals. For example, the audio component 810 includes a microphone (MIC). The microphone is configured to receive external audio signals when the terminal 800 is in the operating mode, such as a call mode, a recording mode, and a speech recognition mode. The received audio signals may be further stored in the memory 804 or sent via the communication component 816. In some embodiments, the audio component 810 also includes a speaker for outputting the audio signals.

The I/O interface 812 provides an interface between the processing component 802 and peripheral interface modules. The peripheral interface modules may be keyboards, click wheels, buttons, etc. These buttons may include but are not limited to: a home button, a volume button, a start button, and a lock button.

The sensor component 814 includes one or more sensors to provide various aspects of state assessment for the terminal 800. For example, the sensor component 814 may detect an open/closed state of the terminal 800, relative positioning of components that are for example a display and keypad of the terminal 800. The sensor component 814 may also detect a position change of the terminal 800 or of a component of the terminal 800, presence or absence of the user contacting with the terminal 800, an orientation or acceleration/deceleration of the terminal 800, and a temperature change of the terminal 800. The sensor component 814 may include a proximity sensor configured to detect the presence of nearby objects without any physical contact. The sensor component 814 may also include a light sensor, such as a CMOS or CCD image sensor, for use in an imaging application. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as WiFi, 2G, 3G, or a combination of them. In an exemplary embodiment, the communication component 816 receives, via a broadcast channel, a broadcast signal or broadcast related information from an external broadcast management system. In an exemplary embodiment, the communication component 816 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to execute the above methods.

In an exemplary embodiment, a non-transitory computer-readable storage medium including instructions is also provided, such as the memory 804 including the instructions. The above instructions may be executed by the processor 820 of the terminal 800 to complete the above methods. For example, the non-transitory computer-readable storage medium may be a ROM, a random access memory (RAM), a CD-ROM, a magnetic tape, a floppy disk, an optical data storage device, etc.

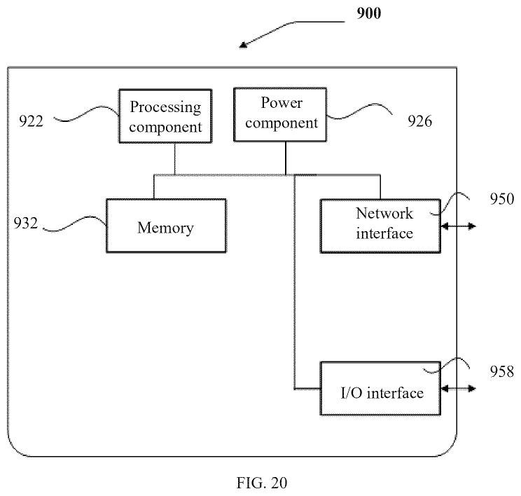

As shown in FIG. 20, an embodiment of the present disclosure shows a structure of a base station. For example, the base station 900 may be provided as a network-side device. Referring to FIG. 20, the base station 900 includes a processing component 922 that further includes one or more processors, and memory resources represented by a memory 932, for storing instructions that is executable by the processing component 922, such as an application program. The application program stored in the memory 932 may include one or more modules that each corresponds to a set of instructions. In addition, the processing component 922 is configured to execute instructions to execute any method applied to the base station in the above methods

The base station 900 may also include a power component 926 configured to execute power management of the base station 900, a wired or wireless network interface 950 configured to connect the base station 900 to the network, and an input/output (I/O) interface 958. The base station 900 may operate an operating system stored in the memory 932, such as Windows Server™, Mac OS X™, Unix™, Linux™, FreeBSD™, or a similar operating system.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the drawings, and various modifications and changes may be made without departing from its scope. The scope of the present disclosure is limited only by the appended claims.

Listing of claims:

1. A method for determining transmission direction, executed by an access network device and comprising:
sending configuration information of at least one sub-band to a terminal;
wherein the configuration information is for the terminal to determine one or more transmission directions in which data is transmitted on the at least one sub-band in one or more target transmission units.

2. The method of claim 1, wherein the one or more target transmission units comprise at least one of:
a symbol,
a slot,
a subframe, or
a radio frame.

3. The method of claim 1, wherein the configuration information comprises one of:
first configuration information, for indicating that one or more transmission directions in which data is transmitted on a target sub-band in one or more target transmission units are one or more downlink transmission directions;
second configuration information, for indicating that one or more transmission directions in which data is transmitted on a target sub-band in one or more target transmission units are one or more uplink transmission directions; or
third configuration information, for indicating that one or more transmission directions in which data is transmitted on a target sub-band in one or more target transmission units are one or more uncertain transmission directions.

4. The method of claim 1, wherein the configuration information comprises one or more of:
direction indication information, for indicating the transmission direction; or
sub-band configuration information, for indicating at least one of:
a number of the at least one sub-band, or
a frequency of the at least one sub-band.

5. The method of claim 1, wherein the sending configuration information of at least one sub-band to a terminal comprises:
sending the configuration information of the at least one sub-band to the terminal with a system message.

6. The method of claim 5, wherein the configuration information comprises available time information for indicating at least one of:
an effective duration of the configuration information, or an effective time of the configuration information.

7. A method for determining transmission direction, executed by a terminal and comprising:
receiving configuration information of at least one sub-band sent by an access network device; and
determining, according to the configuration information, one or more transmission directions in which data is transmitted on the at least one sub-band in one or more target transmission units.

8. The method of claim 7, wherein the one or more target transmission units comprise at least one of:
a symbol,
a slot,
a subframe, or
a radio frame.

9. The method of claim 7, wherein the configuration information comprises one of:
first configuration information, for indicating that one or more transmission directions in which data is transmitted on a target sub-band in one or more target transmission units are one or more downlink transmission directions;
second configuration information, for indicating that one or more transmission directions in which data is transmitted on a target sub-band in one or more target transmission units are one or more uplink transmission directions; or
third configuration information, for indicating that one or more transmission directions in which data is transmitted on a target sub-band in one or more target transmission units are one or more uncertain transmission directions.

10. The method of claim 7, wherein the configuration information comprises one or more of:
direction indication information, for indicating the transmission direction; or
sub-band configuration information, for indicating at least one of:
a number of the at least one sub-band, or
a frequency of the at least one sub-band.

11. The method of claim 7, wherein the receiving configuration information of at least one sub-band sent by an access network device, comprises:
receiving, with a system message, the configuration information of the at least one sub-band sent by the access network device.

12. The method of claim 11, wherein the configuration information comprises available time information for indicating at least one of:
an effective duration of the configuration information, or an effective time of the configuration information.

13. (canceled)

14. (canceled)

15. An access network device, comprising:
a memory; and
a processor, connected to the memory and configured to;
send configuration information of at least one sub-band to a terminal;
wherein the configuration information is for the terminal to determine one or more transmission directions in which data is transmitted on the at least one sub-band in one or more target transmission units.

16. A non-transitory computer storage medium, storing computer executable instructions; wherein when the computer executable instructions are executed by a processor, the processor is caused to execute the method of claim 1.

17. The access network device of claim 15, wherein the one or more target transmission units comprise at least one of:
a symbol,
a slot,
a subframe, or
a radio frame.

18. The access network device of claim 15, wherein the configuration information comprises one of:
first configuration information, for indicating that one or more transmission directions in which data is transmitted on a target sub-band in one or more target transmission units are one or more downlink transmission directions;
second configuration information, for indicating that one or more transmission directions in which data is transmitted on a target sub-band in one or more target transmission units are one or more uplink transmission directions; or
third configuration information, for indicating that one or more transmission directions in which data is transmitted on a target sub-band in one or more target transmission units are one or more uncertain transmission directions.

19. The access network device of claim 15, wherein the configuration information comprises one or more of:
direction indication information, for indicating the transmission direction; or
sub-band configuration information, for indicating at least one of:
a number of the at least one sub-band, or
a frequency of the at least one sub-band.

20. The access network device of claim 15, wherein the processor is further configured to:
send the configuration information of the at least one sub-band to the terminal with a system message.

21. A terminal, comprising:
a memory; and
a processor, connected to the memory and configured to execute the method of claim 7.

22. A non-transitory computer storage medium, storing computer executable instructions; wherein when the computer executable instructions are executed by a processor, the method of claim 7 can be implemented.
